(19) United States
(12) Patent Application Publication
(10) Pub. No.: US 2025/0265280 A1
(43) Pub. Date: Aug. 21, 2025

(54) CLARIFYING POLICY CONTEXTUAL EXTRACTIVE CHATBOT

(71) Applicant: Wells Fargo Bank, N.A., San Francisco, CA (US)

(72) Inventors: Fanus Arefaine, San Jose, CA (US); Alazare Tsegaye Bati, Charlotte, NC (US); Michael Paul Bortis, Tustin, CA (US); Narsingh Rao Chatla, Hyderabad (IN); Austin Lee Grelle, Riverside, IL (US); Siddharth Jain, Bengaluru (IN); Guangcao Ji, Plano, TX (US); Carlton Jay Lindgren, JR., Denver, CO (US); Pradyut K. Parida, Hyderabad (IN); Manesh Saini, New York, NY (US); Yashjeet Singh, Bengaluru (IN); Winthrop Treynor Smith, Littleton, CO (US); Ronald Louis Sobey, Porter, TX (US)

(21) Appl. No.: 18/582,921

(22) Filed: Feb. 21, 2024

(51) Int. Cl. G06F 16/332; G06F 16/33; G06F 16/338

(52) U.S. Cl. CPC G06F 16/3329; G06F 16/3331; G06F 16/338; G06Q 40/02

(57) ABSTRACT

A chatbot system described herein uses a two-staged approach to answer a question. The first stage consists of a contextual search that takes in the question, searches a library of documents and finds a relevant piece of text. The second stage is to use the relevant piece of text, present it to a large language model, and have the model answer the question give the context of the text. The model in question formulates the answer by extracting the most relevant section of the text. When asked an ill-posed question, the chat bot will ask the user clarifying questions until a well-defined question is found.

### BACKGROUND

Chatbots are tools or systems of tools that can be used to provide answers, fulfill tasks, or obtain information from users of various services. In an ideal scenario, a chatbot can be implemented to provide these services without customer wait time, off hours, or uneven service levels from different human representatives.

However, in their current form, many chatbots can be frustrating to use because they lack the ability to ask follow-up questions to properly handle a request. In a scenario where a chatbot lacks the ability to meaningfully respond, the chatbot may provide unsatisfactory service or require intervention from another source such as a customer service representative or programmer.

### SUMMARY

According to a first aspect, a method described herein includes: a) receiving a query via a user interface; b) performing a contextual search of a plurality of documents based on the query to identify relevant materials therein; c) formulating a response to the query by extracting the relevant materials; d) presenting a clarifying question based on the response using a large language model to revise the query; and e) repeating b) through d) until the query is sufficiently well-defined and well-posed to generate a corresponding answer. The corresponding answer can then be presented via the user interface.

In some embodiments, the relevant materials can include a set of criteria corresponding to each of the plurality of documents. At least a subset of the criteria can be displayed on a graphical user interface. A portion of the subset of the criteria that are resolved can be displayed differently than a portion of the subset of the criteria that are unresolved. The set of criteria can include features of a plurality of account types corresponding to the plurality of documents. Presenting a clarifying question based on the response can include determining a most efficient clarifying question based on the contextual search to arrive at a sufficiently well-defined and well-posed question. The method can include engineering a prompt delivered to the large language model based on an expected user and the plurality of documents.

According to a second aspect, a system described herein can include a user interface, a chatbot system communicatively coupled to the user interface to receive a query therefrom, a policies database communicatively coupled to the chatbot system such that the chatbot system can perform a contextual search on a plurality of documents stored in the policies database based on the query to identify relevant materials, a completeness analyzer communicatively coupled to both the policies database and the chatbot system, the completeness analyzer configured to determine whether the relevant materials are sufficient to deliver a complete answer to the query, and a large language model usable by the chatbot system to generate clarifying questions for presentation at the user interface based on the determination by the completeness analyzer.

The relevant materials can include a set of criteria corresponding to each of the plurality of documents. The user interface can be a graphical user interface. A portion of the set of criteria that are resolved can be displayed on the graphical user interface differently than a portion of the subset of the criteria that are unresolved. The set of criteria can include features of a plurality of account types corresponding to the plurality of documents. The graphical user interface can include a chat log for presenting the clarifying questions. The chatbot system can include an engineered prompt based on an expected user and the plurality of documents.

A system according to a third aspect disclosed herein includes a user interface and a computer-readable medium. The computer-readable medium stores instructions that, when executed by a processor: a) receive a query via the user interface; b) perform a contextual search of a plurality of documents based on the query to identify relevant materials therein; c) formulate a response to the query by extracting the relevant materials; d) present a clarifying question based on the response using a large language model to revise the query; and e) repeat b) through d) until the query is sufficiently well-defined and well-posed to generate a corresponding answer. When executed by the processor, the instructions on the computer-readable medium can present the corresponding answer via the user interface.

The relevant materials can include a set of criteria corresponding to each of the plurality of documents. The system can display at least a subset of the criteria on a graphical user interface, wherein a portion of the subset of the criteria that are resolved are displayed differently than a portion of the subset of the criteria that are unresolved. The set of criteria can include features of a plurality of account types corresponding to the plurality of documents. Presenting a clarifying question based on the response can include determining a most efficient clarifying question based on the contextual search to arrive at a sufficiently well-defined and well-posed question. The system can further include an engineered prompt delivered to the large language model based on an expected user and the plurality of documents.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 depicts a system for contextual search and extractive answering.

FIG. 2 illustrates a method for completeness analysis in a contextual search and extractive answering system.

FIG. 3 depicts a simplified set of entities and corresponding criteria within a policy database used in a contextual search and extractive answering system.

FIG. 4 depicts an example of a graphical user interface used in completeness analysis.

FIG. 5 depicts an example block diagram of a virtual or physical operating environment.

### DETAILED DESCRIPTION

Chatbot systems can frustrate those who must interact with them by failing to efficiently accomplish a desired objective. One solution to these frustrations has been to develop chatbot systems that follow overly formulaic patterns, which may waste time and computing resources going through unnecessary questions. Existing chatbots do not efficiently ascertain the user's need by requesting the most relevant information. Additionally, even where a formulaic, tree-style system is used, not every user's scenario may be contemplated. Formulaic decision-tree style systems also require maintenance, as changes to available options and answers to questions may need to be updated over time.

To solve these problems, an example chatbot system as described herein uses a two staged approach to answer a question. The first stage includes a contextual search that takes the question, searches a library of documents and finds a relevant piece of text. The second stage includes using the relevant piece of text, presenting it to a large language model, and having the model answer the question give the context of the text. The model in question formulates the answer by extracting the most relevant section of the text. When asked an ill-posed question, the chat bot can ask the user clarifying questions until a well-defined question is found. The chatbot system will then answer the question.

The large language model can be designed using prompt engineering to allow the chatbot system to determine if required information is missing and ask clarifying questions without necessarily having to explicitly program for each possible request and clarifying questions. These clarifying questions can be developed using completeness analysis, by determining which follow-up question or questions will obtain the most relevant information and therefore most efficiently determine the user's need and provide the relevant information in response.

A chatbot system as described herein can be used to answer questions about policies, given a large library of policies. In one context, there may be 10,000 or more policies, each multiple pages long, that are used by the chatbot system. Importantly, any one of these policies may change over time. For example, one of the policies may relate to a type of bank account and include various parameters or criteria relevant to that type of bank account including minimum account balance, type of account, and restrictions or benefits of the account.

At any given time, any of these parameters could be modified, and the parameter change may be either global or it may be related to only one or some of the policies. As an example of a change to a single policy, the minimum balance requirement on a particular type of account could be updated. As an example of a policy change affecting some types of accounts, the Federal Deposit Insurance Company may change the minimum insured amount, affecting all checking and savings accounts. As an example of a policy change affecting all accounts, a bank or other financial institution that offers a number of account types may make a general policy change affecting all of the accounts it holds.

A chatbot system having access to these policies can automatically develop and ask questions of the user until a well posed question about the policies is developed. When asked an ill-posed question, the chat bot will ask the user clarifying questions until a well-defined question is found. A well-defined question might include things such as what Line of Business, related risks, or a specific business function (such as checking accounts compared to accounts in general), or related laws at the federal, state and municipal level.

As used herein, the terms “ill-posed” or “ill-defined” are contrasted with “well-posed” or “well-defined.”

An “ill-posed” question is one that is ambiguous or unclear, such that clarifying questions may be required to ascertain the asker's intent. A question that unambiguously conveys the user's need is “well-posed.” An example of an ill-posed question is “How much money do I need for this account?”, because it is not clear from the inquiry whether the user is asking about income requirements, minimum account balance, or a required opening balance, for example.

An “ill-defined” question is one that, while not necessarily ill-posed, lacks sufficient precision to be answered directly. An example of an ill-defined question is “What is the minimum balance requirement for a checking account?” While it is clear what the user wants to know, there may be multiple checking accounts having different minimum balance requirements.

Regardless of whether the input inquiry to the systems described herein is ill-posed, ill-defined, or both, a contextual search and contextual answer can be applied to any subject within the scope of the documents available to the chatbot system.

In one example, a chatbot system was developed that uses a two staged approach to answer a question. The first stage consists of a contextual search that takes the question, searches a library of documents and finds a relevant piece of text. The second stage is to use the relevant piece of text, present it to a large language model and have the model answer the question given the context of the text. The model in question formulates the answer by extracting the most relevant section of the text.

The combination of contextual search and extractive answer is not only more efficient for the user, but also saves significant computational resources. The contextual search and answer framework using completeness analysis allows the chatbot system to work along large language models and allows the integration of large language models. The model can review reference text even as the reference text is updated, identify specific entities and see if the question has all the entities it needs to answer the question. This may involve the model repeatedly asking itself and the user clarifying questions, but in the most efficient way to arrive at the appropriate answer.

In this way, the examples described herein can reduce the amount of input and output interactions with the user. Additionally, the burdensome process of incorporating policy changes into a decision tree for a conventional chatbot system is eliminated, as the chatbot system can autonomously change its contextual questions based on updates to the documents within the database of policies that it accesses.

The drawings depict elements of this disclosure for a more complete understanding of the contextual search, extractive answer, and completeness analysis that can be paired with large language models using a chatbot system.

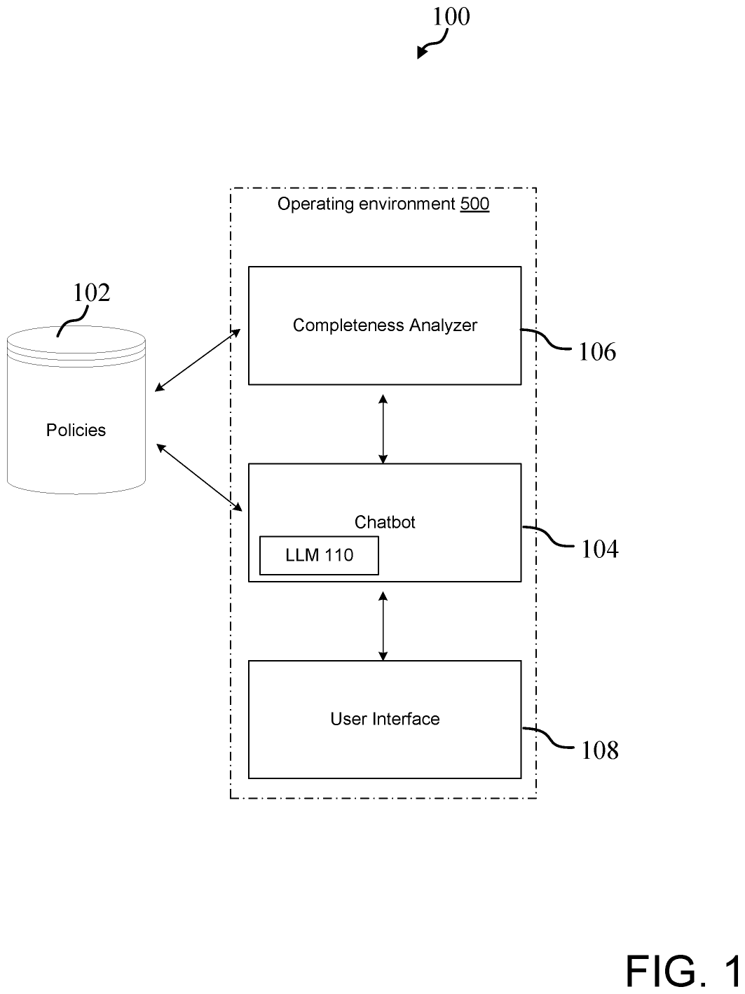

FIG. 1 depicts a system 100 for contextual search and extractive answering, including a policies database 102 and an operating environment 500. The operating environment 500 has sub-components including a chatbot system 104, a completeness analyzer 106, and a user interface 108.

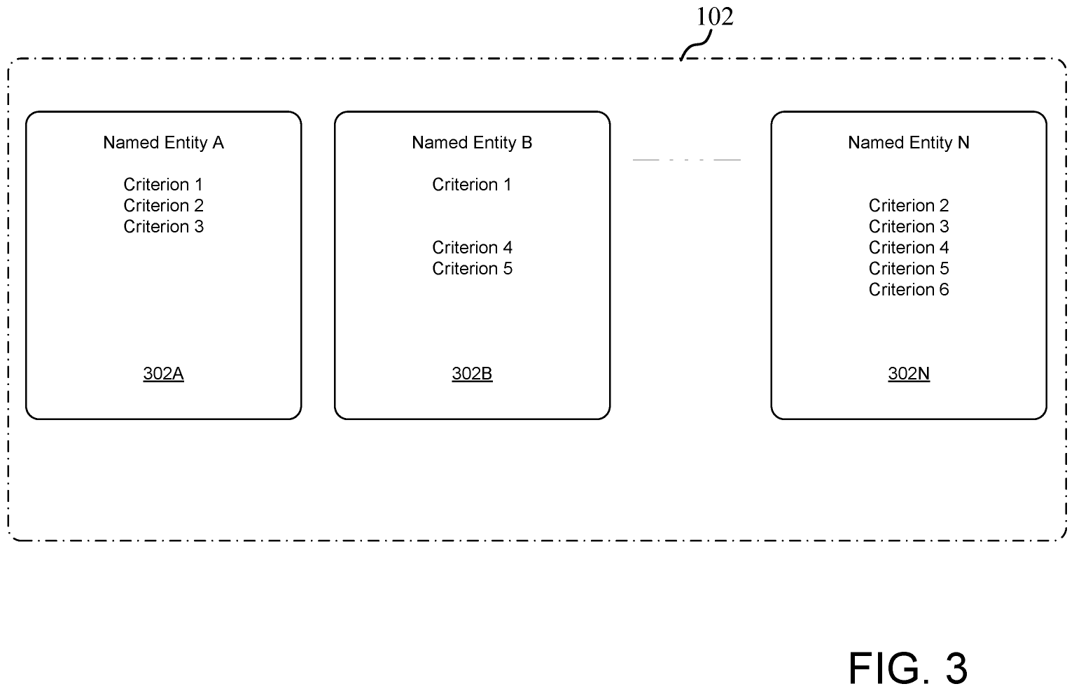

Policies database 102 includes materials that can be searched and analyzed. In one example, policies database 102 includes a multitude of documents related to types of accounts at a financial institution. Each of the documents in the policies database 102 is searchable for criteria of interest. Many of the criteria are shared between different documents, and some criteria may be unique to subsets or individual ones of the documents in policies database 102, as is described in more detail with respect to FIG. 3, below.

Chatbot system 104 is capable of searching and analyzing documents within policies database 102, as depicted by the double arrows therebetween. Chatbot system 104 can perform contextual searches and create extractive answers according to a prompt to a large language model (LLM) 110. LLM 110 is instructed with a prompt that can be a text string passed to LLM 110 to generate a response. The prompt provides clear and specific instructions to LLM 110 so that it can formulate appropriate extractive answers. Prompt engineering involves developing effective prompts to extract the desired output from an LLM, and different prompts may be appropriate for different versions of LLM 110 based on the type of material in policies database 102, or the expected users of the system 100.

Completeness analyzer 106 is coupled to policies database 102 and chatbot system 104. Completeness analyzer 106 can determine, based on the answers extracted by chatbot system 104, whether further contextual searching is required. For example, in a banking context, completeness analyzer 106 can determine whether all appropriate descriptions for determining a type of account to open have been identified by chatbot system 104. Completeness analyzer 106 can also determine if information like account type or minimum balance are still missing that would need to be determined by chatbot system 104 before setting up the account.

User interface 108 is an input/output mechanism for interaction between chatbot system 104 and a user. In one embodiment, user interface 108 can be a graphical user interface. In other embodiments, user interface 108 could be a telephonic communication system, an in-home audio assistant, a vehicle navigation display, or any other similar interactive audio, graphical, or video interface, or a combination thereof.

User interface 108 is shown as being within operating environment 500. For example, operating environment 500 could be a financial institution's server and associated web portal, accessible to the user through a browser or application programming interface (not shown). In other embodiments, other user devices outside of the operating environment 500 can be used as a user interface.

Operating environment 500 uses each of the completeness analyzer 106, the chatbot system 104 (including LLM 110), and the user interface 108 to perform contextual search, extractive answer, and completeness analysis.

Reference text can be provided to chatbot system 104 using LLM 110, such as: “This financial institution offers three types of accounts: savings, checking and brokerage accounts. For a checking account we have two options, one has a minimum balance of $100 and the other has a minimum deposit of $1,000. We can also offer overdraft protection. The saving account requires a minimum deposit of $1,000. The brokerage account needs to be opened by a human being due to regulatory complexities.” This information would be fed in to chatbot system 104 and provided to users or used by chatbot system 104 to prepare extractive answers that facilitate satisfactory completeness analysis at the completeness analyzer 106.

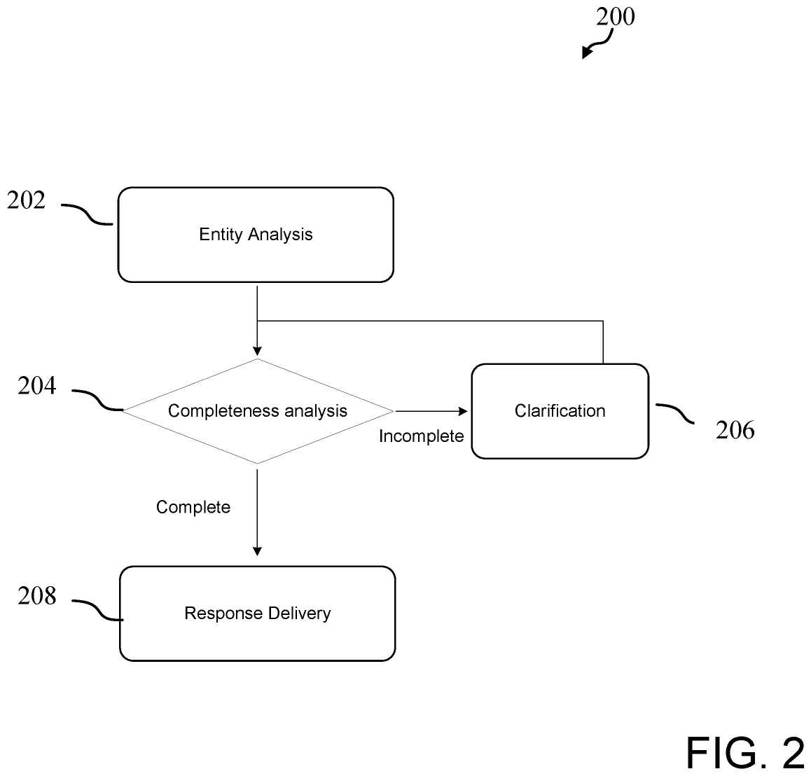

Completeness analysis can be better understood with reference to FIG. 2, which shows a method 200 for completeness analysis in a contextual search and extractive answering system. In these examples, the method 200 can be performed by the completeness analyzer 106, although other configurations are possible.

Method 200 begins with entity analysis 202. Entity analysis 202 includes review of a set of entities and extracting relevant information. In the example of a financial institution having a set of policies relevant to corresponding account types in a policies database (e.g., FIG. 1, policies database 102), entity analysis 202 can include extracting account type and corresponding minimum balance or other similar requirements, features, and attributes (collectively referred to herein as “criteria”). When an inquiry is received (e.g., via user interface 108, FIG. 1) the method 200 can include re-running the entity analysis 202 either on a complete corpus of materials, or on materials that have been updated or added since the last operation of method 200.

Method 200 takes the output of entity analysis 202 and uses it as an input, along with a user inquiry, for completeness analysis 204. Completeness analysis 204 determines whether all of the required information to deliver a complete answer (or form a well-defined and well-posed question) has been received from the user.

If, at completeness analysis 204, it is determined that less than all of the required information to deliver a complete answer has been received, or that there is insufficient information to form a well-defined and well-posed question, then the method 200 proceeds along the “Incomplete” arrow.

When completeness analysis is determined at 204 to be incomplete, clarification occurs at 206. At clarification 206, clarifying questions are posed to the user via the chatbot system to obtain any missing information. As shown in FIG. 2, the cycle of completeness analysis 204 and clarification 206 can be repeated as many times as required to obtain a well-posed, well-defined question and corresponding complete answer.

Clarification 206 poses questions that are informed by the completeness analysis 204. For example, completeness analysis 204 may involve determining what kinds of information would be necessary to resolve a user's ill-posed or ill-defined question, and it may be that some types of questions will arrive more quickly at the complete answer that satisfies the user's intended inquiry. Therefore completeness analysis 204, and the determination of which criteria are yet unresolved, may inform the chatbot system (e.g., chatbot system 104 of FIG. 1) and corresponding large language model (e.g., LLM 110 of FIG. 1) regarding which clarifying questions are most helpful at clarification 206.

Completeness analysis 204 is complete once a well-posed, well-defined answer with a corresponding complete answer can be presented to the user. This is depicted by the downward-pointing arrow from completeness analysis 204 in FIG. 2, towards response delivery 208.

In one example incorporating the method 200 of FIG. 2 in the system 100 of FIG. 1, the chatbot system 104 needs to determine if it has the following entities defined in the question:
Account: Savings, checking, or brokerage;
Within checking: Minimum deposit, overdraft protection;
Within savings: Minimum deposit;
Within brokerage: always refer the user to a human operator rather than continuing with chat.

Continuing this example, when dealing with a checking account, the LLM 110 is used to check that the entities are complete:
Minimum deposit;
Overdraft protection;
If not complete ask the customer for the information;
If complete go to next step;
If all required entities are available, give a response, if not continue clarifying.

FIG. 3 shows criteria associated with a set of entities, saved within policies database 102 (see FIG. 1). The entities of FIG. 3 include Named Entity A (302A), Named Entity B (302B), and Named Entity N (302N), as well as dashed lines indicating that there can be any arbitrarily large number of Named Entities. In the examples described above, each Named Entity may correspond to a particular account type offered by a financial institution.

Each named entity 302A, 302B, . . . 302N depicted in FIG. 3 has a corresponding set of criteria, but not all of which overlap. Named Entity A (302A) includes criterion 1, criterion 2, and criterion 3. Named Entity B (302B) has criterion 1 in common with Named Entity A (302A), but also includes criterion 4 and criterion 5. Named entity N (302N) includes criterion 2 and criterion 3 in common with Named Entity A (302A), and criterion 4 and criterion 5 in common with Named Entity B (302B), but also has criterion 6 that is not shared with either of the other two named entities.

Examples of criteria usable in a financial system can include type of account, minimum balance, whether a human operator is required to open the account, geographical borders or restrictions on the account, interest rates, overdraft protection, foreign transaction or other fees associated with particular types of use of the account, and other parameters that might be of interest to a person interacting with the chatbot system. It is clear that some of these may not apply to all types of accounts, as depicted in FIG. 3 in which some criteria are shown related to some entities but not others.

It can be appreciated that when a user input to a chatbot system specifies some criteria but not others, forming a well-defined question may require resolving one or more of the other criteria that are not specified by that user input. For example, if criterion 1 corresponds to checking accounts, and a user asks a question about checking accounts, forming the well-defined question may involve resolving one or more of criteria 2-5 in FIG. 3.

Contextual search can therefore involve determining which of the criteria must be resolved to form the well-defined question. Extractive answering can involve using a large language model via a chatbot system to pose clarifying questions that resolve those criteria in an efficient manner. Completeness analysis involves determining that enough criteria have been resolved that a well-defined, well-posed question can be answered.

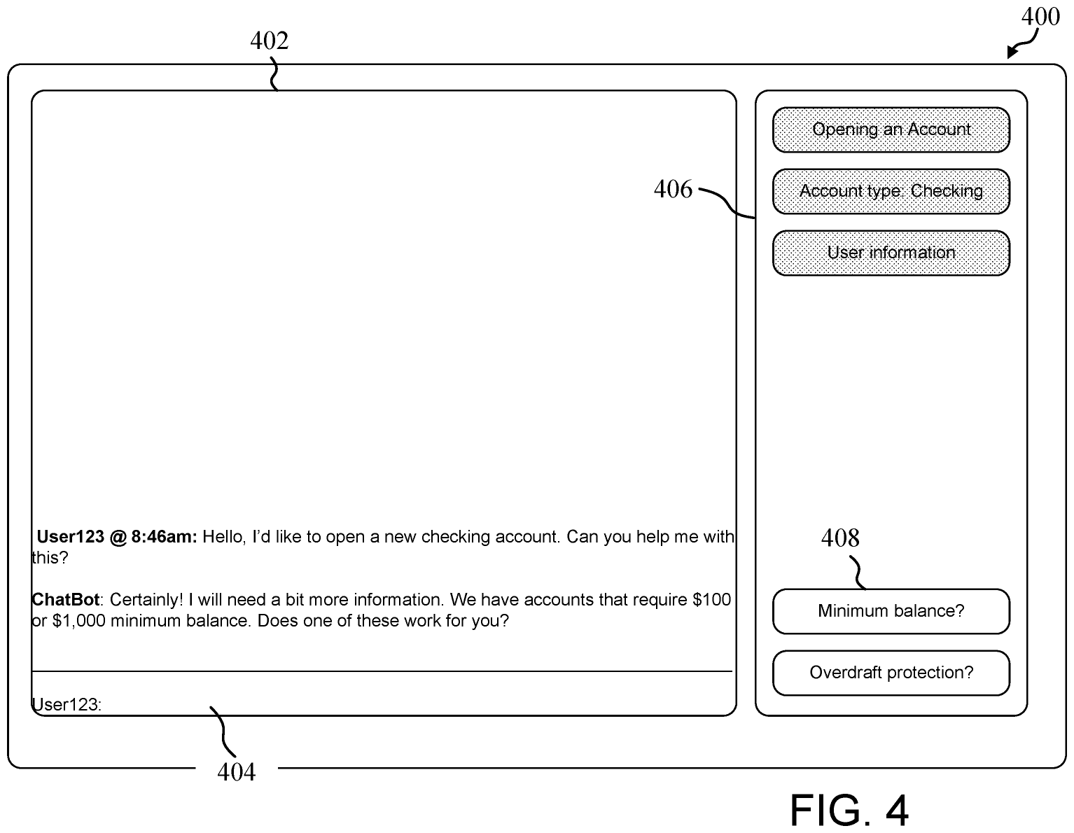

FIG. 4 is an example of a graphical user interface 400 that can be used to present indicators corresponding to the completeness analysis, such as selected criteria that will aid a user in arriving at a desired answer as efficiently as possible.

As shown in FIG. 4, a chat log 402 within the graphical user interface 400 provides a history of a conversation between a user and the chatbot system 104. A prompt line 404 allows a user to ask questions and respond to follow-up questions from the chatbot system.

On the right-hand side of the graphical user interface 400 of FIG. 4 is an indicator bar 406. The indicator bar 406 shows the criteria 408 that it has already resolved (at the top of the indicator bar 406, shaded) and those criteria 408 that it still needs to resolve (unshaded, at the bottom of the indicator bar 406).

Throughout a typical chat session, the number of indicators 408 may increase or decrease as the completeness analysis changes. By displaying the most relevant indicators 408 that are not yet resolved, a user may be able to provide better information to the chatbot system to efficiently arrive at a well-defined, well-posed question and corresponding answer. Additionally, to the extent that the chatbot system 104 has inaccurately understood the user, the resolved indicators 408 at the top of the indicator bar 406 can indicate to the user that there has been a misunderstanding and it can be corrected.

### Examples

In an example, an ill-posed and ill-defined question is provided by a user to the chatbot system 104 as described herein. The conversation between the user and the chatbot system 104 is provided below:
Customer: I need to open an account
Chatbot: Would you like a checking, savings or brokerage account?
Customer: Checking please
Chatbot: We have accounts that require $100 or $1,000 minimum balance. Does one of these work for you?
Customer: I would like the $100
Chatbot: There is an option of having overdraft protection, would you like that?
Customer: Yes please
Chatbot: I am opening a checking account with a minimum deposit of $100 and overdraft protection.

In this Example, the initial question made clear that the user wished to open an account, but did not provide sufficient information for the chatbot system to determine what kind of account the user wished to open. The chatbot system determined that the clarifying question that would most efficiently arrive at a well-defined, well-posed request was what kind of account to open as between checking, savings, or brokerage.

The information provided by the customer in response to the first clarifying question could have been sufficient to arrive at a well-defined, well-posed question having a corresponding answer. For example, the customer could have listed a specific name of a specific checking account option. Alternatively, the customer could have indicated that he or she wished to open a brokerage account, for which a human operator would be needed instead of further chatbot assistance.

Since the user's question still left some ambiguity to the request, the chatbot system continued looping through additional clarifying questions until the completeness analysis was complete.

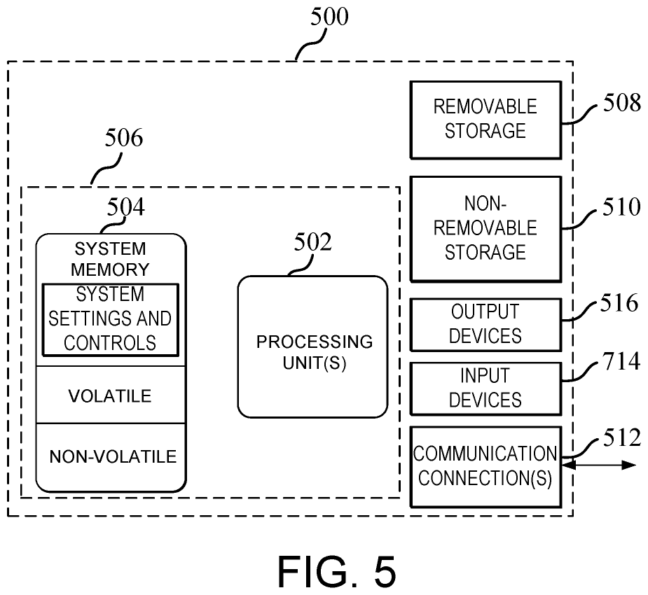

FIG. 5 depicts one example of a suitable operating environment 500 in which one or more of the present examples can be implemented, as referred to above with respect to FIG. 1. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 500 typically includes at least one processing unit 502 and memory 504. Depending on the exact configuration and type of computing device, memory 504 (storing, among other things, instructions to control the eject the samples, move the stage, or perform other methods disclosed herein) can be volatile (such as RAM), non-volatile (such as ROM, flash memory, etc.), or some combination of the two. This most basic configuration is illustrated in FIG. 5 by dashed line 506. Further, operating environment 500 can also include storage devices (removable, 508, and/or non-removable, 510) including, but not limited to, magnetic or optical disks or tape. Similarly, environment 500 can also have input device(s) 514 such as touch screens, keyboard, mouse, pen, voice input, etc., and/or output device(s) 516 such as a display, speakers, printer, etc. Also included in the environment can be one or more communication connections 512, such as LAN, WAN, point to point, Bluetooth, RF, etc.

Operating environment 500 typically includes at least some form of computer readable media. Computer readable media can be any available media that can be accessed by processing unit 502 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 500 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by operating environment 500 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, operating environment 500 is part of a network that stores data in remote storage media for use by the operating environment 500.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For example, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A method comprising:
a) receiving a query via a user interface;
b) performing a contextual search of a plurality of documents based on the query to identify relevant materials therein;
c) formulating a response to the query by extracting the relevant materials;
d) presenting a clarifying question based on the response using a large language model to revise the query;
e) repeating b) through d) until the query is sufficiently well-defined and well-posed to generate a corresponding answer; and
f) presenting the corresponding answer via the user interface.

2. The method of claim 1, wherein the relevant materials comprise a set of criteria corresponding to each of the plurality of documents.

3. The method of claim 2, further comprising displaying at least a subset of the set of criteria on a graphical user interface.

4. The method of claim 3, wherein a portion of the subset of the set of criteria that are resolved are displayed differently than a portion of the subset of the set of criteria that are unresolved.

5. The method of claim 2, wherein the set of criteria comprise features of a plurality of account types corresponding to the plurality of documents.

6. The method of claim 1, wherein presenting the clarifying question based on the response comprises determining a most efficient clarifying question based on the contextual search to arrive at the sufficiently well-defined and well-posed question.

7. The method of claim 1, further comprising engineering a prompt delivered to the large language model based on an expected user and the plurality of documents.

8. A system comprising:
a user interface;
a chatbot system communicatively coupled to the user interface to receive a query therefrom;
a policies database communicatively coupled to the chatbot such that the chatbot can perform a contextual search on a plurality of documents stored in the policies database based on the query to identify relevant materials;
a completeness analyzer communicatively coupled to both the policies database and the chatbot, the completeness analyzer configured to make a determination whether the relevant materials are sufficient to deliver a complete answer to the query; and
a large language model usable by the chatbot to generate clarifying questions for presentation at the user interface based on the determination by the completeness analyzer.

9. The system of claim 8, wherein the relevant materials comprise a set of criteria corresponding to each of the plurality of documents.

10. The system of claim 9, wherein the user interface is a graphical user interface.

11. The system of claim 10, wherein a portion of the set of criteria that are resolved are displayed on the graphical user interface differently than a portion of the set of criteria that are unresolved.

12. The system of claim 10, wherein the set of criteria comprise features of a plurality of account types corresponding to the plurality of documents.

13. The system of claim 10, wherein the graphical user interface comprises a chat log for presenting the clarifying questions.

14. The system of claim 10, wherein the chatbot comprises an engineered prompt based on an expected user and the plurality of documents.

15. A system comprising:
a user interface; and
a computer-readable medium storing instructions that, when executed by a processor, cause the system to:
a) receive a query via the user interface;
b) perform a contextual search of a plurality of documents based on the query to identify relevant materials therein;
c) formulate a response to the query by extracting the relevant materials;
d) present a clarifying question based on the response using a large language model to revise the query;
e) repeat b) through d) until the query is sufficiently well-defined and well-posed to generate a corresponding answer; and
f) present the corresponding answer via the user interface.

16. The system of claim 15, wherein the relevant materials comprise a set of criteria corresponding to each of the plurality of documents.

17. The system of claim 16, comprising further instructions that, when executed by the processor, cause the system to display at least a subset of the set of criteria on a graphical user interface, wherein a portion of the subset of the set of criteria that are resolved are displayed differently than a portion of the subset of the set of criteria that are unresolved.

18. The system of claim 16, wherein the set of criteria comprise features of a plurality of account types corresponding to the plurality of documents.

19. The system of claim 15, wherein presenting the clarifying question based on the response comprises to determine a most efficient clarifying question based on the contextual search to arrive at the sufficiently well-defined and well-posed question.

20. The system of claim 15, comprising further instructions that, when executed by the processor, cause the system to engineer a prompt delivered to the large language model based on an expected user and the plurality of documents.
